(19) United States
(12) Patent Application Publication
(10) Pub. No.: US 2026/0132293 A1
(43) Pub. Date: May 14, 2026

(54) INK-REPELLENT MEMBER, METHOD OF PRODUCING INK-REPELLENT MEMBER, INK JET HEAD, AND METHOD OF PRODUCING ARTICLE

(71) Applicant: CANON KABUSHIKI KAISHA, Tokyo (JP)

(72) Inventors: TADAHIRO MIMURA, Kanagawa (JP); YOHEI MIYAUCHI, Tokyo (JP); JUNRI ISHIKURA, Tokyo (JP); KOJI SASAKI, Chiba (JP)

(21) Appl. No.: 19/385,487

(22) Filed: Nov. 11, 2025

(30) Foreign Application Priority Data
Nov. 12, 2024 (JP) 2024-197079

(51) Int. Cl. C09D 5/16; B41J 2/14; B41J 2/165; C09D 171/02

(52) U.S. Cl. CPC C09D 5/1662; B41J 2/1433; B41J 2/16502; C09D 171/02

(57) ABSTRACT

An ink-repellent member, an ink jet head, and a liquid ejection apparatus that are each excellent in performance. The ink-repellent member includes an underlying portion that contains a metal oxide and has a fluorine compound bonded to a surface thereof. A covalent bond index of a metal element and oxygen of the metal oxide is 0.44 or less, and a ratio of an atom amount of the metal element with respect to a total of a carbon atom amount, an oxygen atom amount, a fluorine atom amount, a silicon atom amount, and the atom amount of the metal element is 1 atm % or less in measurement by X-ray photoelectron spectroscopy on the surface of the underlying portion after the ink-repellent member is subjected to an immersion treatment.

### BACKGROUND

### Field of the Technology

The present disclosure relates to an ink-repellent member, a method of producing an ink-repellent member, an ink jet head, and a method of producing an article.

### Description of the Related Art

As a device that ejects an ink (hereinafter referred to as “ink jet head”), there have been known a bubble jet head that instantaneously vaporizes an ink through use of a heater to fly liquid droplets, a piezo jet head that propels liquid droplets through use of a piezoelectric element, and the like. In order to record a high-quality image through use of an ink jet head, it is required that ink droplets be ejected from ejection orifices for ejecting an ink while their straightness is kept along a predetermined direction. However, when a liquid droplet residue adheres to an orifice plate surface on the periphery of the ejection orifices, ink droplets are dragged by the residue at the time of ejection of the ink droplets to cause deflection in an ejection direction, with the result that the ink droplets may fly out of the predetermined direction. In view of the foregoing, in order to suppress the adhesion of the liquid droplet residue on the periphery of the ejection orifices, an ink-repellent film is formed on the periphery of the ejection orifices to provide an ink-repellent member.

For example, in Japanese Patent Laid-Open No. 2015-003483, there is disclosed that an underlying portion formed of an inorganic oxide is formed on an orifice plate surface, and a fluorine-containing silane coupling agent (hereinafter sometimes referred to as “fluorine compound”) is chemically bonded thereto to form an ink-repellent member.

In addition, in an ink jet head, in order to remove a liquid droplet residue, paper dust, and the like, the orifice plate surface is generally cleaned with a wiper or the like. Thus, the ink-repellent member is required to have ink resistance and sliding resistance.

### SUMMARY

There has been a demand for an ink-repellent member excellent in performance even in the case where an underlying portion contains a metal oxide having low reactivity.

According to an aspect of the present disclosure, there is provided an ink-repellent member including: an underlying portion that contains a metal oxide; and a fluorine compound bonded to a surface thereof, wherein a covalent bond index of a metal element and oxygen of the metal oxide is 0.44 or less, and wherein a ratio of an atom amount of the metal element with respect to a total of a carbon atom amount, an oxygen atom amount, a fluorine atom amount, a silicon atom amount, and the atom amount of the metal element is 1 atm % or less in measurement by X-ray photoelectron spectroscopy on the surface of the underlying portion after the ink-repellent member is subjected to the following immersion treatment steps (1) and (2):
immersion treatment step (1): a test piece including the surface of the underlying portion is cut out of the ink-repellent member, is placed in a sealable container containing a fluorine solvent containing a hydrofluoroether having a boiling point of 60° C. or more, and is immersed in the fluorine solvent so that the test piece is entirely immersed therein; and
immersion treatment step (2): the test piece is maintained at 60° C. for 4 hours in a sealed state after the immersion in step (1).

Further, according to an aspect of the present disclosure, there is provided a method of producing an ink-repellent member including an underlying portion that contains a metal oxide, and has a fluorine compound bonded to a surface thereof, wherein a covalent bond index of a metal element and oxygen of the metal oxide is 0.44 or less, and wherein the method includes the following steps (1), (2), (3), and (4):
(1) subjecting the surface of the underlying portion to plasma treatment under an atmosphere having an oxygen concentration of 50 vol % or more;
(2) applying a fluorine compound having a reactive silyl group represented by the following formula (1) onto the surface of the underlying portion subjected to the plasma treatment in the step (1), followed by dehydration condensation:

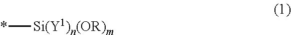

in the formula (1), “n” and “m” each independently represent an integer of from 0 to 3, and n+m=3 is satisfied, each Y¹ independently represents an alkyl group, a chloro group, or a bromo group, each R independently represents a hydrogen atom or an alkyl group, and “*” represents a bonding position in the fluorine compound;
(3) allowing the fluorine compound applied to the underlying portion in the step (2) to be present for 48 hours or more under an environment at a temperature of 25° C.±2° C. and a humidity of 50±10% RH to bond to the surface of the underlying portion; and
(4) heating the fluorine compound and the surface of the underlying portion after the step (3).

Further, according to an aspect of the present disclosure, there is provided an ink jet head including: the above-mentioned ink-repellent member; and an ejection orifice arranged on a side of the ink-repellent member on which the underlying portion is arranged, the ejection orifice being configured to eject a liquid. Further, according to another aspect of the present disclosure, there is provided a method of producing an article including: ejecting a liquid through use of the above-mentioned ink jet head, wherein the liquid is an ink containing a functional material for forming one of a functional thin film and a functional element.

Features of the present disclosure will become apparent from the following description of embodiments with reference to the attached drawings. The following description of embodiments is described by way of example.

### BRIEF DESCRIPTION OF THE DRAWINGS

FIG. 1A is a top view of an ink jet head 100 according to one embodiment of the present disclosure.

FIG. 1B is a bottom view of the ink jet head 100 according to one embodiment of the present disclosure.

FIG. 1C is a partial perspective view for illustrating part of a cross-section taken along the line A-A′ illustrated in each of FIG. 1A and FIG. 1B.

FIG. 2A is a schematic view for illustrating a state of an ink-repellent member according to one embodiment of the present disclosure.

FIG. 2B is a view for illustrating a relationship between a flat portion and a convex portion in an irregular structure in a surface of the ink-repellent member according to one embodiment of the present disclosure.

FIG. 3 is a graph showing a relationship between a treatment time and a ratio of a tantalum atom amount [atm %] when the ink-repellent member according to one embodiment of the present disclosure and the ink-repellent member in the related art are subjected to immersion treatment.

### DESCRIPTION OF THE EMBODIMENTS

An ink-repellent member, an ink jet head, and the like according to embodiments of the present disclosure are described with reference to the drawings. In the following, for example, the terms “ink repellency,” “ink-repellent member,” “ink-repellent agent,” and “ink-repellent film” are described, but may be read as “water repellency,” “water-repellent member,” “water-repellent agent,” and “water-repellent film” assuming an aqueous ink. In addition, when the present disclosure is carried out, it is not necessarily required to limit the kind and application of a liquid, and hence the terms “ink repellency,” “ink-repellent member,” “ink-repellent agent,” and “ink-repellent film” may be read as “liquid repellency,” “liquid-repellent member,” “liquid-repellent agent,” and “liquid-repellent film” in the following description. The embodiments described below are examples, and for example, the detailed configuration may be appropriately changed and carried out by a person skilled in the art without departing from the spirit of the present disclosure.

In the drawings referred to in the description of the following embodiments and Examples, elements with the same reference symbols have the same functions unless otherwise stated. In addition, the description “XX or more and YY or less” or “XX to YY” representing a numerical range means a numerical range including XX (lower limit) and YY (upper limit) that are end points unless otherwise stated. When the numerical ranges are described in stages, the upper limits and lower limits of the respective numerical ranges may be arbitrarily combined.

Herein, a liquid to be handled may be described as “ink”, but the ink is not limited to a liquid for forming a character or an image. For example, the ink may be a liquid containing a functional material for forming a functional thin film, such as an electrode or an optical filter, or a functional element such as an organic EL element.

An ink-repellent member according to the present disclosure is an ink-repellent member including: an underlying portion that contains a metal oxide; and a fluorine compound bonded to a surface thereof, in which a covalent bond index of a metal element and oxygen of the metal oxide is 0.44 or less, and in which a ratio of an atom amount of the metal element with respect to a total of a carbon atom amount, an oxygen atom amount, a fluorine atom amount, a silicon atom amount, and the atom amount of the metal element is 1 atm % or less in measurement by X-ray photoelectron spectroscopy on the surface of the underlying portion after the ink-repellent member is subjected to the following immersion treatment steps (1) and (2).

Immersion treatment step (1): a test piece including the surface of the underlying portion (surface of the ink-repellent member) is cut out of the ink-repellent member, is placed in a sealable container containing a fluorine solvent containing a hydrofluoroether having a boiling point of 60° C. or more, and is immersed in the fluorine solvent so that the test piece is entirely immersed therein.

Immersion treatment step (2): the test piece is maintained at 60° C. for 4 hours in a sealed state after the immersion in step (1).

The term “ink-repellent member” as used herein refers to a member including an underlying portion having a surface to which a fluorine compound is bonded (member including an underlying portion having a fluorine compound bonded to a surface thereof).

The inventors have made investigations repeatedly in order to obtain an ink-repellent member that can maintain ink resistance and sliding resistance for a long time period even when an oxide of a metal (e.g., transition metal) having a covalent bond index with oxygen of 0.44 or less is used as the underlying portion. As a result, the inventors have found that the above-mentioned object can be achieved by subjecting the metal oxide to plasma treatment under an oxygen atmosphere, leaving the resultant in the state of being applied thereto the fluorine compound under an environment at a temperature of 25° C.±2° C. and a humidity of 50±10% RH for 48 hours or more, and then bonding the fluorine compound by heating. The ink resistance of the ink-repellent member refers to, for example, a small change in contact angle, which is one of the performance indices of the ink-repellent member, even when the ink-repellent member is in contact with an ink for a long time period. In the case of bonding a fluorine-containing silane coupling agent to the underlying portion, silicon oxide is generally used as the underlying portion, but as in Japanese Patent Laid-Open No. 2015-003483, a transition metal element having high liquid resistance may be added to the underlying portion. However, it has been known that when a metal element (hereinafter also referred to as “M”) to be added to a metal oxide underlying portion has a small covalent bonding property with oxygen, the reactivity is low, and an M-O bond to be formed between the silane coupling agent and M added to the underlying portion is hardly formed. In addition, a transition metal oxide has excellent liquid resistance, but depending on the kind of element, its covalent bonding property with oxygen is small, and it is difficult to form a bond with a silane coupling agent containing a fluorine compound generally used as an ink-repellent agent. In view of the foregoing, the inventors have found that there is a disadvantage in that, in an ink-repellent member using, for example, a transition metal oxide for its underlying portion, the ability of the ink-repellent member is reduced owing to prolonged ink contact and sliding.

However, as a result of extensive investigations made by the inventors, the inventors have found that many bonds are formed by leaving the ink-repellent member in the state of being applied thereto the fluorine compound for 48 hours or more under an environment at a temperature of 25° C.±2° C. and a humidity of 50±10% RH, and then heating the fluorine compound. Further, the inventors have found that an irregular structure including the fluorine compound is also formed on the surface of the ink-repellent member. This irregular structure is continuously formed on a film in which one or more ink-repellent films of the fluorine compound are laminated. When a reaction is slowly performed under an environment close to room temperature, not only a bond between a silane coupling functional group of the ink-repellent film and the underlying portion but also a bond between molecules of the fluorine compound is formed, and hence a stronger bond network is formed. As a result of the formation of the strong network, a local irregular structure appears on the layered ink-repellent film. It is conceived that by leaving the ink-repellent member under the above-mentioned conditions, a high-density ink-repellent film is formed and hence an ink-repellent member excellent in ink resistance and sliding resistance can be achieved.

### (Ink Jet Head)

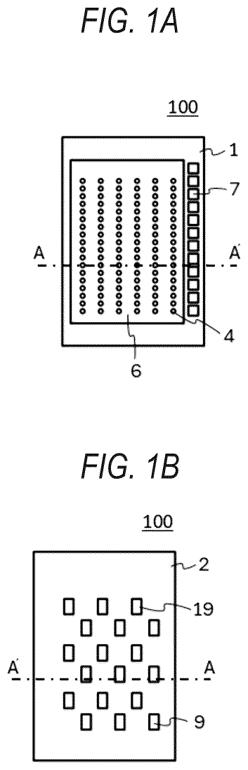

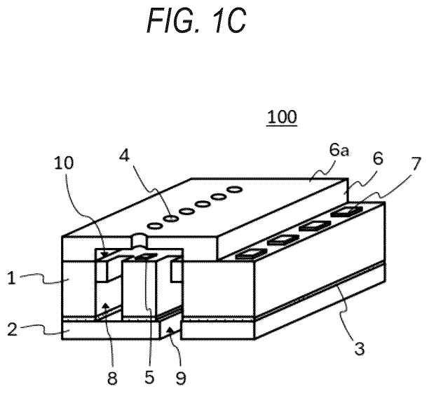

First, an ink jet head according to one embodiment of the present disclosure may be an ink jet head including: the ink-repellent member according to the present disclosure; and an ejection orifice arranged on a side of the ink-repellent member on which the underlying portion is arranged, the ejection orifice being configured to eject a liquid. The configuration of the ink jet head according to this embodiment is described. FIG. 1A is a top view of an ink jet head 100 according to this embodiment. FIG. 1B is a bottom view of the ink jet head 100.

In addition, FIG. 1C is a partial perspective view for illustrating part of a cross-section taken along the line A-A′ illustrated in each of FIG. 1A and FIG. 1B.

The ink jet head 100 may include a first flow path substrate 1 serving as a first member, a second flow path substrate 2 serving as a second member, an adhesive layer 3, ejection orifices 4, ejection energy-generating elements 5, an orifice plate 6 (ink-repellent member), electrodes 7, and an ink tank chamber. The ink tank chamber is not shown in FIG. 1A to FIG. 1C. In addition, among the constituent components of the ink jet head, components that are not directly related to the description of the present disclosure (e.g., an electric circuit and wiring) are not shown.

A set of the first flow path substrate 1 and the second flow path substrate 2, a set of the first flow path substrate 1 and the orifice plate 6, and a set of the second flow path substrate 2 and the ink tank chamber are each bonded to be integrated with each other via the adhesive layer 3 to form a flow path structure. In the flow path structure, a first through-flow path 8, a second through-flow path 9, and a third through-flow path 19 are formed and communicate to each other to form an ink supply path. In FIG. 1C, only part of the adhesive layer 3 is illustrated for the sake of convenience in illustration.

The ink is supplied from the ink tank chamber to a liquid flow path 10 through the second through-flow path 9 formed in each of the second flow path substrate 2 and the first flow path substrate 1, and is ejected from the ejection orifices 4 after being given ejection energy by the ejection energy-generating elements 5. The ink that has not been ejected from the ejection orifices 4 flows back to the ink tank chamber through the first through-flow path 8 formed in the first flow path substrate 1 and the third through-flow path 19 (circulation return path) formed in the second flow path substrate 2.

Although the plurality of ejection orifices 4 are arranged in the orifice plate 6, an arrangement method (number and position) for the ejection orifices 4 is not limited to the illustrated example. The orifice plate 6 has, on an outer surface thereof, that is, an orifice surface 6a that is a surface on an opposite side to the liquid flow path 10, an underlying portion to be described later, and a fluorine compound is bonded to the surface of the underlying portion. Thus, the ink-repellent film is formed. On the ejection orifices 4 arranged on the orifice surface 6a, the ink-repellent film is not formed. On the first flow path substrate 1, the ejection energy-generating elements 5 for ejecting a liquid are arranged at positions corresponding to the respective ejection orifices 4, and the ejection energy-generating elements 5 are driven in response to an electric signal transmitted from outside via the electrodes 7. For example, electrothermal conversion elements or piezoelectric elements are suitably used as the ejection energy-generating elements 5. Silicon is suitable as a material to be used for a base material of the orifice plate 6, but silicon carbide, silicon nitride, various glasses, such as quartz glass and borosilicate glass, various ceramics, such as alumina and gallium arsenide, and resins such as polyimide may each be used as the material in addition to silicon. In this embodiment, the orifice plate is formed of the ink-repellent member, but the ink jet head itself may be formed of the ink-repellent member.

### (Underlying Portion)

An underlying portion to be arranged on, for example, the outer surface (orifice surface 6a) of the orifice plate 6 illustrated in FIG. 1C is formed so as to contain an inorganic oxide. The underlying portion has a hydroxy group formed on a surface thereof and hence can form a chemical bond with a fluorine compound having a reactive silyl group (fluorine-containing silane coupling agent). Through the formation of the chemical bond, the adhesiveness between the underlying portion and the fluorine compound can be improved. The underlying portion may be formed on the base material as an underlying film or an underlying layer. However, when the base material itself (bulk material) is formed so as to contain an inorganic oxide, the base material itself may be used as the underlying portion.

In the present disclosure, the underlying portion contains an oxide of a metal (e.g., transition metal) having a covalent bond index with oxygen of 0.44 or less as an inorganic oxide. Such metal oxide as described above has excellent liquid resistance. A covalent bonding property of a metal element in a metal oxide with oxygen may be calculated from the electronegativity of each of the metal element and oxygen. When this value is large, the covalent bonding property is high, and it is easy to form a bond with oxygen. In contrast, when this value is small, it is difficult to form a bond with oxygen. The same can be conceived for the ease of bond formation with a generally used silane coupling agent. A covalent bond index E indicating the covalent bonding property with oxygen may be introduced from the following equation (A).

$$E = exp \{ - 0.25 {( {χ}_{M} - {χ}_{O} )}^{2} \} \qquad ( A )$$

Here, χM represents the electronegativity of the metal element, and χO represents the electronegativity of oxygen. The values of electronegativities handled in the present disclosure are referred to Pauling's electronegativity, and are set as follows: oxygen: 3.4, tantalum: 1.5, zirconium: 1.3, and hafnium: 1.3. In the present disclosure, a metal element having a covalent bond index E with oxygen of 0.44 or less is investigated.

Examples of the metal element of the metal oxide in the present disclosure include transition metals (transition elements) of Groups 3 to 11 of the periodic table, and examples thereof include tantalum, zirconium, and hafnium. In particular, tantalum is preferred from the viewpoint of a ratio of an oxygen atom amount on the surface when formed into a metal oxide. Examples of the underlying portion in the present disclosure include tantalum pentoxide, zirconium dioxide, and hafnium dioxide. In particular, tantalum pentoxide is preferred from the viewpoint of the ratio of the oxygen atom amount on the surface.

As the underlying portion containing the metal oxide, for example, an underlying film may be formed on a base material (e.g., silicon) by a sputtering method, an ion-assisted vapor deposition method, an atomic layer deposition (ALD) method, or the like. Of those, the ALD method is preferably used from the viewpoint of being capable of forming a high-density film. When the density is high, the ink resistance to an alkaline ink is further improved.

When the underlying film is formed as the underlying portion on the base material, silicon is generally used as the base material of a lower layer of the underlying film. In this case, a thickness of the underlying portion is preferably 10 nm or more, more preferably 50 nm or more from the viewpoint of protecting silicon from an ink. In addition, the thickness is preferably 300 nm or less, more preferably 200 nm or less from the viewpoint of suppressing the cohesive failure at the time of sliding.

### (Surface Treatment of Underlying Portion)

A method of producing an ink-repellent member according to one embodiment of the present disclosure is a method of producing an ink-repellent member including an underlying portion that contains a metal oxide, and has a fluorine compound bonded to a surface thereof, in which a covalent bond index of a metal element and oxygen of the metal oxide is 0.44 or less, the method including the following steps (1), (2), (3), and (4):
(1) subjecting the surface of the underlying portion having no fluorine compound bonded thereto to plasma treatment under an atmosphere having an oxygen concentration of 50 vol % or more;
(2) applying a fluorine compound having a reactive silyl group represented by the following formula (1) onto the surface of the underlying portion subjected to the plasma treatment in the step (1), followed by dehydration condensation:

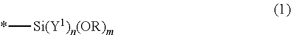

in the formula (1), “n” and “m” each independently represent an integer of from 0 to 3, and n+m=3 is satisfied, each Y¹ independently represents an alkyl group, a chloro group, or a bromo group, each R independently represents a hydrogen atom or an alkyl group, and “*” represents a bonding position in the fluorine compound;
(3) allowing the fluorine compound applied to the underlying portion in the step (2) to be present for 48 hours or more under an environment at a temperature of 25° C.±2° C. and a humidity of 50±10% RH to bond to the surface of the underlying portion; and
(4) heating the fluorine compound and the surface of the underlying portion after the step (3).

The surface treatment of the underlying portion is performed for the purpose of forming a hydroxy group, which is a bonding point with a silane coupling agent, on the surface of the underlying portion. When the surface of the underlying portion that contains the metal oxide is subjected to the surface treatment, the surface is brought into a highly active state, and a hydroxy group is formed by its reaction with moisture in the air. A silane coupling reaction between this hydroxy group and the fluorine compound can form an M-O—Si bond on the surface.

Examples of a surface treatment method include plasma treatment of applying plasma in a vacuum and sputtering treatment using argon. In the present disclosure, plasma treatment under an oxygen atmosphere is preferred. This is because even when a large amount of energy is applied to the surface to blow off oxygen, the oxygen may be able to fill the void when the surrounding is an oxygen atmosphere, and a hydroxy group can be formed at high density.

In the present disclosure, the oxygen concentration of the atmosphere in the step (1) of performing the plasma treatment is preferably 50 vol % or more, more preferably 75 vol % or more, still more preferably 80 vol % or more. The treatment may be performed under an atmosphere containing only oxygen (oxygen concentration is 100 vol %).

In addition, a bias may be applied in order to perform the treatment by accelerating the plasma generated during the treatment. As a result, the surface treatment is accelerated, and a hydroxy group can be further formed.

In the case where an oxide of a transition metal is used as the underlying portion, when the plasma treatment is performed under an oxygen atmosphere, the amount of a hydroxy group that is a reactive group can be increased, and many bonds with a fluorine compound are formed. Thus, an ink-repellent member excellent in sliding resistance and ink resistance can be achieved.

### (Fluorine Compound)

The fluorine compound to be used in the ink-repellent member according to the present disclosure has a linear main chain structure, and one of the ends on both sides of the main chain can form a chemical bond (M-O—Si) with the hydroxy group on the surface of the metal oxide of the underlying portion. The fluorine compound to be used in the production of the ink-repellent member in order to form the M-O—Si bond has at least one reactive silyl group represented by the following formula (1).

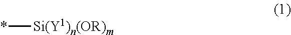

In the formula (1), “n” and “m” each independently represent an integer of from 0 to 3, and n+m=3 is satisfied. For example, “m” may represent 3, and “n” may represent 0. Each Y¹ independently represents an alkyl group, a chloro group, or a bromo group. Each R independently represents a hydrogen atom or an alkyl group. It is preferred that each Y¹ represents a methyl group. When the number of carbon atoms of Y¹ is small, a decrease in reactivity caused by steric hindrance is easily suppressed. It is preferred that each R represents a methyl group because the hydrolysis of the fluorine compound becomes faster, and the reaction becomes faster.

In addition, the fluorine compound preferably has a perfluoromethyl structure (perfluoromethyl group) at the other end. The perfluoromethyl structure has small surface free energy and can express high ink repellency.

The main chain structure of the fluorine compound preferably has a perfluoropolyether (hereinafter sometimes referred to as “PFPE”) structure from the viewpoint of ensuring ink repellency and sliding resistance.

That is, a preferred structure of the fluorine compound to be used in the production of the ink-repellent member may be represented by the following formula (10).

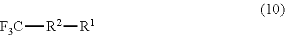

In the formula (10), R¹ represents the reactive silyl group represented by the formula (1), and R² represents a structure having a perfluoropolyether structure.

The fluorine compound preferably has, as the PFPE structure, at least one of a repeating structure represented by the following formula (2), a repeating structure represented by the following formula (3), a repeating structure represented by the following formula (4), and a repeating structure represented by the following formula (5).

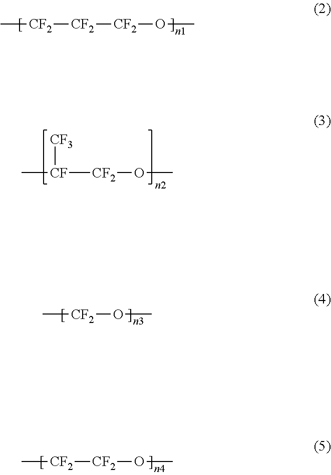

In the formulae (2), (3), (4), and (5), n1, n2, n3, and n4 each independently represent an integer of 1 or more.

Preferred specific examples of the fluorine compound include a compound represented by the following formula (6), a compound represented by the following formula (7), a compound represented by the following formula (8), and a compound represented by the following formula (9):

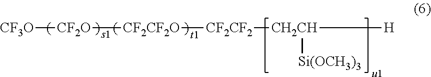

in the formula (6), s1, t1, and u1 each independently represent an integer of 1 or more;

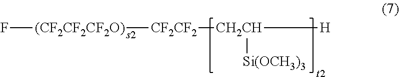

in the formula (7), s2 and t2 each independently represent an integer of 1 or more;

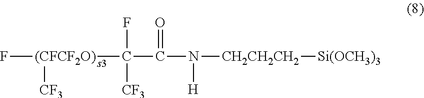

in the formula (8), s3 represents an integer of 1 or more; and

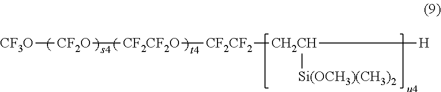

in the formula (9), s4, t4, and u4 each independently represent an integer of 1 or more.

The fluorine compound in the ink-repellent member is preferably a fluorine compound that has a main chain having a perfluoropolyether structure and has a perfluoromethyl group at its end. That is, a preferred structure of the fluorine compound in a state in which the fluorine compound is bonded to the surface of the underlying portion containing the metal oxide via an M-O—Si bond may be represented by the following formula (11):

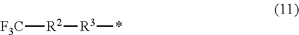

in the formula (11), R² represents a structure having a perfluoropolyether structure, R³ represents a Si—O bond, and the fluorine compound is chemically bonded to the surface of the underlying portion via an M-O—Si bond containing the Si—O bond, and “*” represents a bonding position with respect to a metal atom (M).

The number average molecular weight of the fluorine compound is preferably 4,000 or more. The number average molecular weight of the fluorine compound may be calculated, for example, by ¹⁹F-NMR measurement based on the integral ratio with respect to the CF₃ group at the end.

### (Method of Producing Ink-Repellent Member)

Subsequently, a method of bonding a fluorine compound to a surface of an underlying portion containing a metal oxide is described. The fluorine compound may be bonded by silane coupling treatment. An example thereof is described below.

First, for example, an underlying portion that is an underlying film containing a metal oxide is formed on a substrate such as an orifice plate. An example of a method of forming a metal oxide as an underlying film is a method of forming a metal oxide by an atomic layer deposition (ALD) method.

Next, a hydroxy group is formed on the surface of the underlying portion by the above-mentioned plasma treatment. Next, a fluorine compound is applied to the surface of the underlying portion having the hydroxy group formed thereon. There is no particular limitation on a method for the application, and examples thereof may include a vacuum vapor deposition method, a thermal vapor deposition method, a spray coating method, a spin coating method, and a dip coating method.

Subsequently, an alkoxysilyl group or a halogenated silyl group at the end of the fluorine compound is hydrolyzed to be converted to a silanol group (Si—OH group). Then, the silanol group of the fluorine compound and the hydroxy group formed on the surface of the underlying portion are subjected to a dehydration condensation reaction to form an M-O—Si bond. In addition, depending on the oriented state of the fluorine compound, a Si—O—Si bond is also formed between molecules of the fluorine compound.

Hydrolysis is caused by exposure of the silane coupling functional group at the end of the fluorine compound to moisture, and is also caused by adsorbed water that exists on the surface of the underlying portion. The dehydration condensation reaction occurs also at room temperature, and may be accelerated by raising the temperature.

When a fluorine compound is bonded to an underlying portion that contains a metal oxide, at a temperature around room temperature (e.g., 25° C.±2° C.), reaction energy required for bonding is insufficient, and bonding between molecules of the fluorine compound (Si—O—Si) may be liable to occur. In the related art, in order to promote bonding between a fluorine compound and a metal oxide underlying portion (M-O—Si), the density of an ink-repellent film has been increased by heating the applied fluorine compound at high temperature to cause a reaction.

However, when the reaction is promoted by heating at high temperature, the density of the ink-repellent film does not change regardless of whether the heating time is long or short. This is because when a bonding reaction is rapidly promoted under a high temperature condition, a silane coupling functional group around the underlying portion bonds to the underlying portion, but a silane coupling functional group that does not bond to the underlying portion bonds to another silane coupling functional group. As a result, the number of bonds around the underlying film does not change, and hence heating at high temperature does not lead to an increase in density.

In the present disclosure, a reaction is caused for a long time period under mild conditions so as to purposely promote bonding between molecules of the fluorine compound. In this way, the silane coupling functional groups of the fluorine compounds move to an optimal position for each molecule while repeating hydrolysis and dehydration condensation. This enables the formation of a denser and wider-ranging bonding network. Specifically, it is preferred that the fluorine compound applied to the underlying portion be allowed to be present under an environment at a temperature of 25° C.±2° C. and a humidity of 50±10% RH for 48 hours or more, more preferably 96 hours or more, still more preferably 168 hours or more.

After that, the applied fluorine compound is heated to 100° C. or more to promote bonding between the fluorine compound and the underlying portion. This enables the formation of a high-density ink-repellent film through the bonding of the fluorine compound having a dense bonding network to the underlying portion.

Further, with a conventional production method, an aggregate of fluorine compound molecules formed by bonding between the molecules of the fluorine compound does not contribute to bonding to the underlying portion, and thus has been removed in a washing step. When the aggregate is left under mild conditions for a long time period as in the present disclosure, the aggregate is also incorporated as part of the network, and remains on the surface of the ink-repellent film even after washing. This aggregate is also formed of the fluorine compound, and hence contributes to both the ink resistance and sliding resistance of the ink-repellent member.

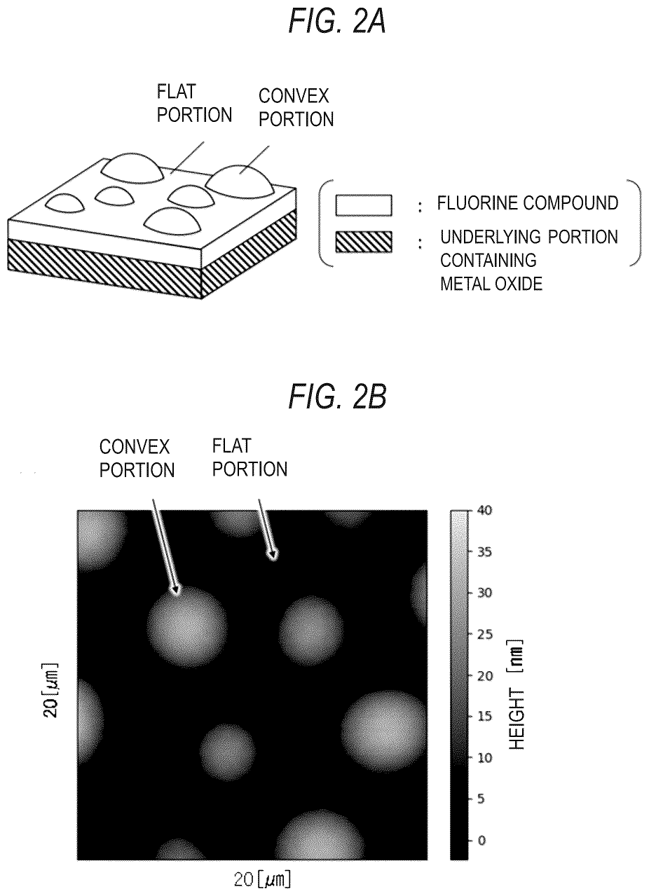

It is preferred that the ink-repellent member according to the present disclosure have an irregular structure including the fluorine compound. As shown in FIG. 2A, the above-mentioned aggregate appears as an irregular structure on the surface of the ink-repellent member. When the ink-repellent film formed on the surface has a flat portion and a convex portion, an improvement in contact angle by virtue of the lotus leaf effect can be expected. In addition, it can be said that the ink-repellent member as a whole has a longer life than that of one without a flat portion or a convex portion because its wear starts from the convex portion during sliding. At this time, it is preferred that the convex portion be formed such that a distance between the apex of the convex portion and the flat portion is 20 nm or more, and it is more preferred that the convex portion be formed such that the above-mentioned distance is 30 nm or more.

The thickness of the flat portion of the ink-repellent film formed of the fluorine compound is preferably 1 nm or more, more preferably 5 nm or more.

After the fluorine compound is bonded to the surface of the underlying portion, the underlying portion is washed so that the remaining unbonded fluorine compound is removed. There is no particular limitation on a method for the washing, but for example, it is only required that the ink-repellent member be immersed in a fluorine solvent that is compatible with the fluorine compound. The underlying portion is washed to the extent that it can be visually observed that the fluorine compound does not remain on the underlying portion.

After the fluorine solvent is dried, the bonding amount of the fluorine compound, ink resistance, and sliding resistance may be evaluated.

### (Ratio of Metal Element in Underlying Portion)

In the ink-repellent member according to one embodiment of the present disclosure, the ratio of the atom amount of the metal element having a covalent bond index with oxygen of 0.44 or less, which is in the underlying portion, is 1 atm % (atomic percentage) or less. The ratio of the atom amount of the metal element may be measured as described below. The ink-repellent member having the fluorine compound bonded thereto is subjected to the following immersion treatment steps (1) and (2). After that, the surface of the ink-repellent member (surface of the underlying portion) is subjected to measurement by X-ray photoelectron spectroscopy (XPS), and the ratio of the atom amount of the metal element with respect to a total of a carbon atom amount, an oxygen atom amount, a fluorine atom amount, a silicon atom amount, and the atom amount of the metal element is calculated. It can be said that as the detection ratio of the metal element in the underlying portion of the ink-repellent film becomes smaller, the density at which the ink-repellent film is formed becomes higher.

Immersion treatment step (1): a test piece including the surface of the underlying portion is cut out of the ink-repellent member, is placed in a sealable container containing a fluorine solvent containing a hydrofluoroether having a boiling point of 60° C. or more, and is immersed in the fluorine solvent so that the test piece is entirely immersed therein.

Immersion treatment step (2): the test piece is maintained at 60° C. for 4 hours in a sealed state after the immersion in step (1).

XPS measurement conditions may be set as described below when the underlying portion contains, for example, a tantalum oxide. The same applies when other metal elements are subjected to the measurement.

Measurement device: Quantera II (product name), manufactured by ULVAC-PHI, Incorporated
X-ray source: AlKα
Analysis region: φ200 μm
Pass energy: 140 eV
Number of scans: 10
Detection angle: 45°
Detection elements: C, O, F, Si, and Ta
XPS peaks: C1s, O1s, F1s, Si2p, and Ta4f

The hydrofluoroether is a compound formed of a carbon atom, a fluorine atom, a hydrogen atom, and an ether bond (—O—). The hydrofluoroether only dissolves the fluorine compound and has no corrosivity. Thus, through the above-mentioned treatment, the fluorine compound, which has not been completely removed in the washing step despite not being chemically bonded to the underlying portion, can be removed. That is, the ink-repellent film that has been actually formed on the underlying film can be evaluated by performing the above-mentioned immersion treatment.

There is no particular limitation on the fluorine solvent containing the hydrofluoroether to be used for the immersion treatment, and examples of commercially available products thereof may include Novec (trademark) 7200 (boiling point: 76° C., manufactured by 3M Company, structure: C₄F₉OC₂H₅), Sumitec Solvent 72 (boiling point: 76° C., manufactured by Sumico Lubricant Co., Ltd.), and SOLBLE RN2000 (boiling point: 76° C., manufactured by SOLVEX Co., Ltd.) (each of which contains a compound having the same structure as that of Novec 7200 as a main component). The fluorine solvent containing the hydrofluoroether may be the hydrofluoroether itself (hydrofluoroether content is 100%).

The unbonded fluorine compound may also contribute to an increase in durability, and hence, in general, the unbonded fluorine compound is actively used without being removed for practical purposes. However, the unbonded fluorine compound is diffused into an ink, for example, during the contact with the ink and is removed over time. As a result, the underlying portion having low liquid repellency is exposed, leading to deterioration of an ink-repellent function. Even when, for example, the ratio of the transition metal atom amount is kept constant before the above-mentioned treatment, the amount bonded to the underlying portion is actually changed by a film-forming process. Thus, an ink-repellent member excellent in ink resistance can be obtained by achieving an ink-repellent member having a small transition metal atom amount after the above-mentioned treatment.

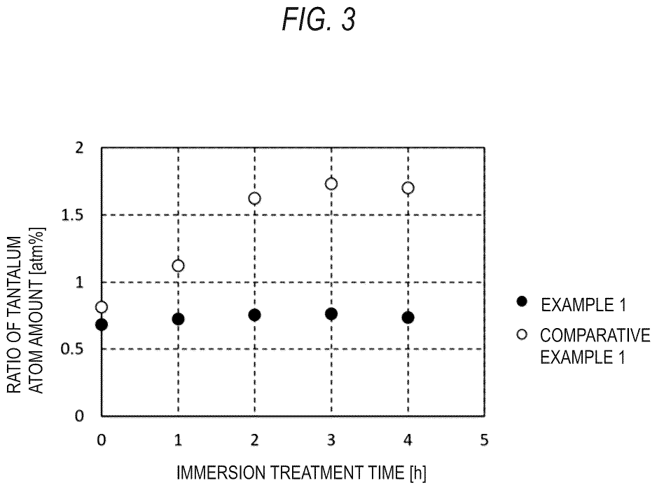

As an example, FIG. 3 shows a change in ratio of an atom amount of the metal element (tantalum) when each of the ink-repellent member according to one embodiment of the present disclosure used in Example 1 described below and the ink-repellent member in the related art used in Comparative Example 1 is subjected to the above-mentioned immersion treatment. The ratio of a tantalum atom amount is the ratio of the tantalum atom amount with respect to the total of a carbon atom amount, an oxygen atom amount, the fluorine atom amount, a silicon atom amount, and the tantalum atom amount.

It is found that the ratio of the atom amount of tantalum is kept constant immediately after the washing step (corresponding to an immersion treatment time of 0 h in FIG. 3), but the ratio of the atom amount of tantalum of the ink-repellent member according to the related art is increased by the above-mentioned immersion treatment. This indicates that a portion where the tantalum oxide of the underlying portion is exposed appears because the fluorine compound that cannot have been completely removed in the washing step and has remained on the surface of the ink-repellent member is removed by the above-mentioned immersion treatment. Meanwhile, it is found that the ratio of the atom amount of tantalum of the ink-repellent member according to the present disclosure is maintained at the time of being kept for 4 hours. This shows that by virtue of the effect of the present disclosure, an aggregate formed by bonding between molecules of the fluorine compound, which would be conventionally removed, is also kept as part of the ink-repellent film, and hence the aggregate is not removed by the immersion treatment, and prevents exposure of the tantalum oxide of the underlying portion. The foregoing values are each stabilized by treatment of 3 hours or more, and hence it is conceived that the removal of the aggregate is completed. Accordingly, in the present disclosure, the ink-repellent member is evaluated by performing the immersion treatment for 4 hours.

The ratio of the atom amount of the metal element after the above-mentioned immersion treatment is preferably 1.0 atm % or less, more preferably 0.80 atm % or less from the viewpoint of ink resistance.

### (Method of Producing Article Including Using Ink-Repellent Member)

A method of producing an article according to one embodiment of the present disclosure may be a method of producing an article including: ejecting a liquid through use of the above-mentioned ink-repellent member (e.g., an ink jet head), in which the liquid is an ink containing a functional material for forming a functional thin film or a functional element. The article may be an intermediate product or a final product. The method of producing an article according to this embodiment is suitable for producing, for example, an article such as an organic EL (OLED) panel through use of the ink jet head. The method of producing an article of this embodiment is advantageous in at least one of performance, quality, productivity, or production cost of an article as compared to the related-art methods.

### EXAMPLES

Specific Examples and Comparative Examples are described below.

### Example 1

Tantalum pentoxide was laminated to 100 nm on a Φ3-inch silicon substrate with an ALD film-forming device.

Next, the silicon substrate having the tantalum pentoxide formed thereon as an underlying film was placed in a chamber of a plasma treatment device, and a surface of the underlying film was treated. Specifically, after the inside of the chamber was evacuated, only oxygen was introduced. Then, plasma was generated, and a bias was applied to accelerate the plasma (output power value: 120 W). This state was maintained for 300 seconds.

Subsequently, the silicon substrate in which the surface of the underlying film was treated was placed in a vacuum vapor deposition machine, and a fluorine compound was deposited from the vapor on the surface having the underlying film formed thereon. The compound having a number average molecular weight of 5,000 represented by the formula (6) was used as the fluorine compound. The vapor deposition was performed in such a manner that 160 mg of the fluorine compound in a state of being impregnated into steel wool was placed in a Cu container and the fluorine compound was heated on a resistance boat.

Subsequently, the silicon substrate having the fluorine compound deposited from the vapor thereon was allowed to stand still for 168 hours under an environment at a temperature of 25° C. and a humidity of 50% RH.

Subsequently, the silicon substrate having the fluorine compound deposited from the vapor thereon was placed in an oven, and was allowed to stand still for 45 minutes under an environment at 120° C.

Subsequently, the taken-out silicon substrate was washed by immersion in a fluorine solvent for 30 seconds so that the fluorine compound adhering to the surface was removed. The washing was repeated twice through use of a fresh fluorine solvent, and the solvent was dried. Thus, an ink-repellent member having the fluorine compound bonded thereto was obtained.

### Example 2

An ink-repellent member was produced by the same method as that in Example 1 except that the conditions were changed to allow the silicon substrate having the fluorine compound deposited from the vapor thereon to stand still for 48 hours under an environment at a temperature of 25° C. and a humidity of 50% RH.

### Example 3

An ink-repellent member was produced by the same method as that in Example 1 except that hafnium oxide was laminated to 100 nm instead of tantalum pentoxide with an ALD film-forming device and used as the underlying film, and the silicon substrate having the fluorine compound deposited from the vapor thereon was allowed to stand still for 48 hours under an environment at a temperature of 25° C. and a humidity of 50% RH.

### Comparative Example 1

An ink-repellent member was produced by the same method as that in Example 1 except that the conditions were changed to allow the silicon substrate having the fluorine compound deposited from the vapor thereon to stand still for 12 hours under an environment at a temperature of 25° C. and a humidity of 50% RH.

Methods of evaluating the underlying portion and the ink-repellent member according to each of Examples and Comparative Example are described.

(Evaluation 1: Ratio of Atom Amount of Metal Element after Immersion Treatment)

The surface of the underlying portion of the ink-repellent member having the fluorine compound bonded thereto was subjected to the following immersion treatment. After that, a ratio of an atom amount of tantalum or hafnium (ratio of the atom amount of tantalum or hafnium with respect to a total of a carbon atom amount, an oxygen atom amount, a fluorine atom amount, a silicon atom amount, and the atom amount of tantalum or hafnium) was measured, followed by the evaluation of a coverage of the metal oxide underlying portion.

Immersion treatment step (1): a test piece (thickness: about 700 μm, area: about 2 cm on each side) including a surface of an underlying portion is cut out of an ink-repellent member, is placed in a sealable container containing a fluorine solvent containing a hydrofluoroether having a boiling point of 60° C. or more (Novec 7200, boiling point: 76° C., manufactured by 3M Company), and is immersed in the hydrofluoroether so that the test piece is entirely immersed therein.

Immersion treatment step (2): the test piece is maintained at 60° C. for 4 hours in a sealed state after the immersion in step (1).

In addition, XPS measurement conditions at the time of Evaluation 1 are as described below.
Measurement device: Quantera II (product name), manufactured by ULVAC-PHI, Incorporated
X-ray source: AlKα
Analysis region: φ200 μm
Pass energy: 140 eV
Number of scans: 10
Detection angle: 45°
Detection elements: C, O, F, Si, and Ta (or Hf)
XPS peaks: C1s, O1s, F1s, Si2p, and Ta4f (or Hf4f)

### (Evaluation 2: Evaluation of Surface Irregular Profile)

The surface profile of the surface of the underlying portion of the ink-repellent member having the fluorine compound bonded thereto after the immersion treatment was measured with an atomic force microscope (Jupiter XR, manufactured by Oxford Instruments). SI-DF40 (manufactured by Hitachi High-Tech Science Corporation) was used as a cantilever, and the measurement was performed in a tapping mode. As shown in FIG. 2B, there was measured the value of a height Z (x, y) at each of positions obtained by dividing an arbitrary measurement region measuring 20 μm by 20 μm into 256 pieces on the surface of a substrate in each of the x-direction and the y-direction. Here, an arbitrary position Nₒ (xₙ, yₙ) and adjacent positions Nₐ (xₙ₋₁, yₙ), N_{b} (xₙ₊₁, yₙ), N_{c} (xₙ, yₙ₋₁), and N_{d} (xₙ, yₙ₊₁) were defined. Heights at the respective positions were Zₒ, Zₐ, Z_{b}, Z_{c}, and Z_{d}.

With regard to the arbitrary position Nₒ, when mₐ=|Zₒ−Zₐ|, m_{b}=|Zₒ−Z_{b}|, m_{c}=|Zₒ−Z_{c}|, and m_{d}=|Zₒ−Z_{d}| were calculated, the position Nₒ was defined as a flat portion when all the values of mₐ, m_{b}, m_{c}, and m_{d} were 1 nm or less. In addition, the minimum height among the flat portions in the region was defined as Zₘᵢₙ. With regard to the arbitrary position Nₒ, when mₒₐ=Zₒ−Zₐ, m_{ob}=Zₒ−Z_{b}, m_{oc}=Zₒ−Z_{c}, and m_{od}=Zₒ−Z_{d} were calculated, the position No was defined as a convex portion when all the values of mₒₐ, m_{ob}, m_{oc}, and m_{od} were positive and at least one of the values was larger than 1 nm. In addition, the maximum height among the convex portions in the region was defined as Zₘₐₓ.

Such a difference between the minimum height Zₘᵢₙ among the flat portions and the maximum height Zₘₐₓ among the convex portions as shown in FIG. 2B was calculated to obtain a distance from the flat portion of the ink-repellent film to the apex of the convex portion.

### (Evaluation 3: Evaluation of Ink Resistance)

The ink resistance of an ink-repellent member having a fluorine compound bonded thereto is evaluated by the following procedure. An alkali dye ink (BCI-7C, manufactured by CANON KABUSHIKI KAISHA) was used as an ink. The ink is placed in a PFA container. The ink-repellent member is immersed in the ink so that the entire surface thereof is brought into contact with the ink, and the container is sealed with a lid. The container is placed in an oven in this state, and a temperature of 70° C. is maintained for 30 weeks. The taken-out ink-repellent member was thoroughly washed with water so that the ink was removed. Then, a receding contact angle was measured and evaluated by the following method.

A contact angle meter (product name: DM-701, manufactured by Kyowa Interface Science Co., Ltd., analysis software: FAMAS (ver. 3.5.5)) was used. Conditions for the measurement were as described below.
Droplets: 2 μL (pure water)
Receding contact angle: the angle was calculated by a sessile drop method.

The receding contact angle was measured specifically by the following method. The contact angle was measured at 80 points at intervals of 15 seconds after the landing of a droplet. The following calculation was performed in the order from a time of 0 seconds through use of the values of the contact angle and the contact radius (unit: μm) at a certain time calculated from the above-mentioned software, and the following processes (A) and (B) were performed.
(A) When the value of a contact radius at a time “t” was represented by Rₜ and the value of a contact radius after t+90 seconds was represented by Rₜ₊₉₀, the value “x” of (Rₜ−Rₜ₊₉₀)² was calculated.
(B) When the value “x” was 200 or less, the process (A) was performed again, and the contact angle at a time “t” when the value “x” first exceeded 200 was defined as the receding contact angle.
A: The receding contact angle is 100° or more.
B: The receding contact angle is 95° or more and less than 100°.
C: The receding contact angle is 90° or more and less than 95°
D: The receding contact angle is 85° or more and less than 90°.

### (Evaluation 4: Evaluation of Sliding Resistance)

The sliding resistance of an ink-repellent member having a fluorine compound bonded thereto is evaluated by the following procedure. A high-density felt material (CS-7, manufactured by Taber Industries) is attached to a friction and wear tester (FPR-2100, manufactured by Rhesca Co., Ltd.) as a sliding material, and a reciprocating sliding test is performed on the surface of the ink-repellent member. The reciprocating sliding test is performed under the conditions of a sliding load of 650 g, a sliding width of 10 mm, a linear velocity of 100 mm/sec, and the number of sliding cycles of 15,000. The receding contact angle of the surface of the ink-repellent member after sliding was measured and evaluated by the method described in Evaluation 3.

The specifications of the ink-repellent members according to Examples 1 to 3 and Comparative Example 1 are collectively shown in Table 1 below.

TABLE 1

| | Metal | | Ratio of atom | Distance between |
|---|---|---|---|---|
| | oxide in | Leaving | amount of | convex portion |
| | underlying | time | tantalum or | apex and flat |
| | portion | [h] | hafnium [atm %] | portion [nm] |
| Example 1 | Ta₂O₅ | 168 | 0.74 | 34.2 |
| Example 2 | Ta₂O₅ | 48 | 0.81 | 26.3 |
| Example 3 | HfO₂ | 48 | 0.94 | 18.5 |
| Comparative | Ta₂O₅ | 12 | 1.70 | 2.3 |
| Example 1 | | | | |

The results of Evaluation 3 and Evaluation 4 of the ink-repellent members according to Examples 1 to 3 and Comparative Example 1 are collectively shown in Table 2 below.

TABLE 2

| | Sliding resistance | Ink resistance |
|---|---|---|
| Example 1 | A | A |
| Example 2 | A | B |
| Example 3 | B | C |
| Comparative Example 1 | C | D |

In order to satisfy practicality as an ink-repellent member, the contact angle is required to be 90° or more. Thus, it can be said that the ink-repellent members according to Examples 1 to 3, which are evaluated to be A to C for both ink resistance and sliding resistance, have more excellent practical characteristics than those of the ink-repellent member according to Comparative Example 1.

In addition, a liquid ejection apparatus including a housing and the above-mentioned ink jet head arranged on the housing may be formed.

According to the present disclosure, an ink-repellent member and an ink jet head that are each excellent in performance can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-197079, filed Nov. 12, 2024, which is hereby incorporated by reference herein in its entirety.

What is claimed is:

1. An ink-repellent member comprising:
an underlying portion that contains a metal oxide; and
a fluorine compound bonded to a surface of the underlying portion,
wherein a covalent bond index of a metal element and oxygen of the metal oxide is 0.44 or less, and
wherein a ratio of an atom amount of the metal element with respect to a total of a carbon atom amount, an oxygen atom amount, a fluorine atom amount, a silicon atom amount, and the atom amount of the metal element is 1 atm % or less in measurement by X-ray photoelectron spectroscopy on the surface of the underlying portion after the ink-repellent member is subjected to immersion treatment steps (1) and (2):
immersion treatment step (1): a test piece including the surface of the underlying portion is cut out of the ink-repellent member, is placed in a sealable container containing a fluorine solvent containing a hydrofluoroether having a boiling point of 60° C. or more, and is immersed in the fluorine solvent so that the test piece is entirely immersed therein; and
immersion treatment step (2): the test piece is maintained at 60° C. for 4 hours in a sealed state after the immersion in step (1).

2. The ink-repellent member according to claim 1, wherein the ink-repellent member has an irregular structure including the fluorine compound.

3. The ink-repellent member according to claim 2,
wherein the irregular structure has a convex portion and a flat portion, and
wherein the ink-repellent member has the convex portion formed such that a distance between an apex of the convex portion and the flat portion is 20 nm or more.

4. The ink-repellent member according to claim 1, wherein the metal element is tantalum.

5. The ink-repellent member according to claim 1, wherein the fluorine compound has a main chain having a perfluoropolyether structure and the fluorine compound has a perfluoromethyl group at an end thereof.

6. The ink-repellent member according to claim 1, wherein the fluorine compound has at least one of a structure represented by formula (2), a structure represented by formula (3), a structure represented by formula (4), and a structure represented by formula (5): 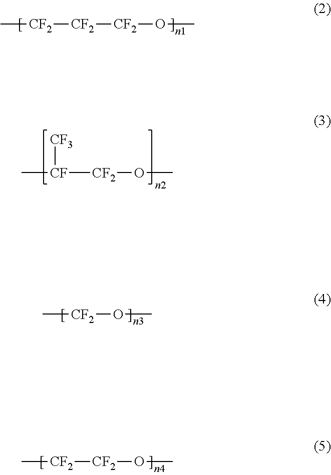
in formulae (2), (3), (4), and (5), n1, n2, n3, and n4 each independently represent an integer of 1 or more.

7. A method of producing an ink-repellent member including an underlying portion that contains a metal oxide, and has a fluorine compound bonded to a surface of the fluorine compound,
wherein a covalent bond index of a metal element and oxygen of the metal oxide is 0.44 or less, and
wherein the method comprises the following steps (1), (2), (3), and (4):
(1) subjecting the surface of the underlying portion to plasma treatment under an atmosphere having an oxygen concentration of 50 vol % or more;
(2) applying a fluorine compound having a reactive silyl group represented by formula (1) onto the surface of the underlying portion subjected to the plasma treatment in step (1), followed by dehydration condensation: 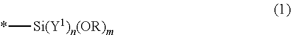
in formula (1), n and m each independently represent an integer of from 0 to 3, and n+m=3 is satisfied, each Y¹ independently represents an alkyl group, a chloro group, or a bromo group, each R independently represents a hydrogen atom or an alkyl group, and * represents a bonding position in the fluorine compound;
(3) allowing the fluorine compound applied to the underlying portion in step (2) to be present for 48 hours or more under an environment at a temperature of 25° C.±2° C. and a humidity of 50±10% RH to bond to the surface of the underlying portion; and
(4) heating the fluorine compound and the surface of the underlying portion after step (3).

8. The method of producing an ink-repellent member according to claim 7, wherein, in step (3), the fluorine compound is allowed to be present under the environment at a temperature of 25° C.±2° C. and a humidity of 50±10% RH for 96 hours or more to bond to the surface of the underlying portion.

9. The method of producing an ink-repellent member according to claim 7, wherein, in step (4), the fluorine compound and the surface of the underlying portion are heated to 100° C. or more to be subjected to dehydration condensation.

10. The method of producing an ink-repellent member according to claim 7, wherein, in step (1), the oxygen concentration is 75 vol % or more.

11. An ink jet head comprising:
the ink-repellent member of claim 1; and
an ejection orifice arranged on a side of the ink-repellent member on which the underlying portion is arranged, the ejection orifice being configured to eject a liquid.

12. A liquid ejection apparatus comprising:
a housing; and
the ink jet head of claim 11.

13. A method of producing an article comprising:
ejecting a liquid through use of the ink jet head of claim 11,
wherein the liquid is an ink containing a functional material for forming one of a functional thin film and a functional element.
